(19) United States
(12) Patent Application Publication
(10) Pub. No.: US 2026/0225257 A1
(43) Pub. Date: Aug. 6, 2026

(54) HYBRID APPROACH TO PERFORM DYNAMIC PROJECTION MAPPING ONTO ROBOTIC FIGURES IN REAL-TIME

(71) Applicant: DISNEY ENTERPRISES, INC., Burbank, CA (US)

(72) Inventors: Prutsdom Jiarathanakul, Glendale, CA (US); Alfredo Medina Ayala, West Covina, CA (US); Joel Jason Peavy, Poway, CA (US); David Powell Goldberg, Altadena, CA (US); Bryan S. Tye, Canyon County, CA (US)

(21) Appl. No.: 19/448,401

(22) Filed: Jan. 14, 2026

Related U.S. Application Data
(60) Provisional application No. 63/755,000, filed on Feb. 6, 2025.

(51) Int. Cl. B25J 11/00; G06T 7/246; H04N 9/31

(52) U.S. Cl. CPC B25J 11/0015; G06T 7/246; H04N 9/3185; G06T 2207/10028; G06T 2207/10048; G06T 2207/30204

(57) ABSTRACT

Systems, methods and apparatuses for a hybrid approach to perform dynamic projection mapping onto robots in real-time are discussed herein. For example, a robotic system includes a projection surface coupled to a robotic structure and configured to be moved by the robotic structure. The robotic system includes a tracking mechanism comprising at least one of a first tracking mechanism positioned internal to the robotic structure and configured to generate intrinsic tracking data or a second tracking mechanism positioned external to the robotic structure and configured to generate extrinsic tracking data. The robotic system includes a controller in communication with the tracking mechanism. The robotic system includes a projector having a field of view aligned with the projection surface and configured to project content onto the projection surface, wherein the controller modifies the projected content based on data generated by the tracking mechanism.

### CROSS REFERENCE TO RELATED APPLICATIONS

The present application is related to and incorporates by reference U.S. Non-Provisional Patent Application Ser. No. 19/407,596 filed on Dec. 3, 2025, and titled “DYNAMIC MECHANICAL SKIN STRUCTURES FOR ANIMATRONIC FIGURES” and U.S. Non-Provisional Patent Application Ser. No. 19/448,327 [Attorney Docket Number P322674.US.02] titled “HYBRID APPROACH TO PERFORM DYNAMIC PROJECTION MAPPING ONTO ROBOTIC FIGURES IN REAL-TIME” filed on Jan. 14, 2026, for all purposes. Additionally, the present application claims priority to U.S. Provisional Patent Application No. 63/755,000 filed on Feb. 6, 2025, and titled “Hybrid Approach to Perform Dynamic Projection Mapping Onto Animatronic Figures in Real-Time,” which is herein incorporated by reference in its entirety.

### FIELD

The present disclosure relates generally to systems and methods for controlling and implementing robotic devices, such as animatronics.

### BACKGROUND

Amusement parks, theme parks, carnivals, arcades, and various attractions use robotic devices, such as animatronics, to produce an interactive effect for guests. For example, animatronics mimic the movement, look, and emotion of characters sharing the theme of the rides, shows, and games, and can interact with guests to provide a truly immersive experience. Additionally, other types of robotic devices appear in everyday life such as in food service environments, manufacturing environments, and social interaction environments, interacting with users and the environment.

Traditional animatronics use mechanical actuators to animate or move different portions of the robotic device, e.g., an animation including movement of an arm includes mechanically moving an appendage of the animatronic. However, such mechanical motions are limited by mechanical constraints, space constraints, and wear rapidly over time. Further, such motions look unrealistic as they are often large and slow motions that are not realistic in appearance.

### SUMMARY

In one embodiment, a robotic system is disclosed. The robotic system includes a projection surface coupled to a robotic structure and configured to be moved by the robotic structure. The robotic system includes a tracking mechanism comprising at least one of a first tracking mechanism positioned internal to the robotic structure and configured to generate intrinsic tracking data, or a second tracking mechanism positioned external to the robotic structure and configured to generate extrinsic tracking data. The robotic system includes a controller in communication with the tracking mechanism. The robotic system includes a projector having a field of view aligned with the projection surface and configured to project content onto the projection surface, wherein the controller modifies the projected content based on data generated by the tracking mechanism.

Optionally, in some embodiments, the tracking mechanism comprises the first tracking mechanism and the second tracking mechanism, and the controller is further configured to combine, using a sensor fusion algorithm, the intrinsic tracking data and the extrinsic tracking data to generate combined tracking data, and use the combined tracking data to further modify the projected content. In some such embodiments, the sensor fusion algorithm weights the intrinsic tracking data and the extrinsic tracking data based on a comparison of the intrinsic tracking data and the extrinsic tracking data to generate the combined tracking data.

Optionally, in some embodiments, the projection surface defines a continuous projection surface over the robotic structure.

Optionally, in some embodiments, the robotic system further comprises an actuator configured to change a topography of a portion of the projection surface of the robotic structure, wherein the tracking mechanism comprises the first tracking mechanism, the first tracking mechanism is coupled to the actuator, and the first tracking mechanism generates the intrinsic tracking data based on movement of the actuator that changes the topography of the portion of the projection surface.

Optionally, in some embodiments, the tracking mechanism comprises the first tracking mechanism, and the first tracking mechanism comprises an inertial measurement unit (IMU), a hall effect detector, an encoder, or a combination thereof.

Optionally, in some embodiments, the tracking mechanism comprises the second tracking mechanism, the second tracking mechanism comprises a visual tracking mechanism configured to track an external change in a topography of a portion of the projection surface, and the second tracking mechanism is positioned within an environment of the robotic structure.

Optionally, in some embodiments, the tracking mechanism comprises the second tracking mechanism, and the second tracking mechanism comprises a light detection and ranging (LiDAR) sensor, camera, infrared (IR) marker reader, radar sensor, or a combination thereof.

Optionally, in some embodiments, the robotic system further comprises a lighting system having a field of view aligned with the projection surface and configured to project light onto one or both of the projection surface and the robotic structure, wherein the controller is further configured to modify the lighting system based on the data generated by the tracking mechanism.

Optionally, in some embodiments, the robotic system further comprises an actuator configured to change a topography of a portion of the projection surface of the robotic structure, wherein the controller is configured to: time align, based on the data generated by the tracking mechanism, the content with the actuator such that the actuator modifies the topography of the portion of the projection surface at a same time as the content is projected on the portion of the projection surface, and spatially align, based on the data generated by the tracking mechanism, the content with the projection surface such that a position where the content is projected is aligned with changes in the topography as the actuator modifies the topography.

In another embodiment, a method for tracking a robot is disclosed. The method includes projecting content on a projection surface of the robot. The method further includes generating tracking data using a tracking mechanism, the tracking mechanism comprising at least one of (i) a first tracking mechanism positioned internal to the robot and configured to generate intrinsic tracking data, or (ii) a second tracking mechanism positioned external to the robot and configured to generate extrinsic tracking data. The method further includes modifying at least one of (i) the content projected on the projection surface, or (ii) mechanical movement of the projection surface based on the tracking data to align the content with the projection surface of the robot.

Optionally, in some embodiments, the projection surface defines a continuous projection surface over the robot.

Optionally, in some embodiments, modifying the content projected on the projection surface comprises one or more of: modifying a timing of the content projected on the projection surface, modifying a position where the content is projected on the projection surface, or modifying an artistic aspect of the content projected on the projection surface.

Optionally, in some embodiments, modifying the mechanical movement of the projection surface comprises one or more of modifying a timing of the mechanical movement, modifying a force value or a torque value of the mechanical movement, or modifying which portion of the projection surface is to be moved by the mechanical movement.

Optionally, in some embodiments, the robot comprises an actuator configured to move to generate the mechanical movement, the tracking mechanism comprises the first tracking mechanism, and the first tracking mechanism generates the intrinsic tracking data based on movement of the actuator.

Optionally, in some embodiments, the tracking mechanism comprises the second tracking mechanism, and the second tracking mechanism is a visual tracking mechanism that generates the extrinsic tracking data based on tracking visual movement of a topography of a portion of the projection surface.

Optionally, in some embodiments, the tracking mechanism comprises the first tracking mechanism and the second tracking mechanism, and the method further comprises analyzing the intrinsic tracking data and the extrinsic tracking data to predict a future position of the robot, a future position of the projection surface, or a combination thereof, and further modifying at least one of the content or the mechanical movement based on the future position of the robot, the future position of the projection surface, or the combination thereof.

In another embodiment, a non-transitory computer-readable media comprising instructions are disclosed. The non-transitory computer-readable media comprising instructions cause a robotic system to generate tracking data using a tracking mechanism, the tracking mechanism comprising at least one of (i) a first tracking mechanism coupled internally to a robotic structure of the robotic system robot and configured to generate intrinsic tracking data, or (ii) a second tracking mechanism positioned externally to the robotic structure robot and configured to generate extrinsic tracking data. The non-transitory computer-readable media comprising instructions further cause the robotic system to modify, based on the tracking data, at least one of (i) content projected on a projection surface of the robotic system, or (ii) mechanical movement of the projection surface to align the content with the projection surface of the robot.

Optionally, in some embodiments, the projection surface defines a continuous projection surface over the robotic structure.

Optionally, in some embodiments, the instructions further cause the robotic system to analyze the tracking data to predict one or both of a future position of the projection surface or a future movement of the projection surface, and further modify at least one of the content projected on the projection surface or the mechanical movement of the projection surface based on the one or both of the future position of the projection surface or the future movement of the projection surface.

Optionally, in some embodiments, the instructions further cause the robotic system to spatially align and time align, based on the tracking data, the content projected on the projection surface, and the mechanical movement of the projection surface.

### BRIEF DESCRIPTION OF THE DRAWINGS

FIG. 1 illustrates a simplified schematic of a system for performing dynamic projection mapping onto animatronics in real-time.

FIG. 2A illustrates an example animatronic with a projection surface positioned over a robotic structure of the animatronic.

FIG. 2B illustrates an example of a projection surface of an animatronic modified to align with content projected onto it.

FIG. 2C illustrates an example of a projection surface of an animatronic and a projection surface of an animatronic modified to align with content projected onto it.

FIG. 3A illustrates a cross section side view of a projection surface with an actuator that is at rest.

FIG. 3B illustrates a cross section side view of a morphed projection surface with an activated actuator.

FIG. 4 illustrates a cross section side view of a projection surface with a modified topography.

FIG. 5 is a flow diagram for tracking an animatronic and aligning content projected onto the projection surface of the animatronic and the mechanical movement of the animatronic.

FIG. 6 illustrates a method for tracking a robot (e.g., an animatronic).

FIG. 7 illustrates a functional block diagram of an animatronic design system of an animatronic operable or controllable according to the hybrid approach discussed herein.

FIG. 8 illustrates a simplified block diagram of components of a computing system of the system of FIG. 1.

### DETAILED DESCRIPTION

Embodiments herein introduce a system and method for animating a robotic device, such as an animatronic. Portions of the animatronic may be animated, such as the movement of a portion of a face, limb, or other element of the animatronic. It should be noted that while many embodiments described herein are with reference to an animatronic, the embodiments are equally applicable to other types of movable systems, such as other robotic devices. Therefore, the term animatronic is not meant to be limiting. The implementation of the animatronic includes a hybrid approach using mechanical actuators combined with content projection, where the content is projected onto a projection surface of the animatronic (e.g., an outer covering or skin of the animatronic). The projection surface or skin may be continuous (e.g., without apertures or other breaks in the skin) or non-continuous.

The mechanical system mechanically actuates portions of the animatronic, e.g., allowing portions of the projection surface to be moved and deformed. The content projection enhances and supplements the mechanical motion. For example, detailed realism, special effects, and artistic elements of facial features, including, but not limited to, skin texture, color, macro and micro animations, wrinkles, cinematic effects, visual effects (VFXs), etc. are projected along with mechanical motion representative of the same animated effect. The overall effect of the mechanical motion and projected content creates a realistic and immersive experience not possible to generate solely with mechanical motion. The combination of topography changes (e.g., via mechanical motion) with the content projection over the same surface of the animatronic introduces realism and allows more complex and detailed implementations for the animatronic, many of which would not be possible to create with just mechanical motion, such as finer or faster motions that cannot be done with mechanical actuators. The implementation of the animatronic includes various human or non-human facial features, expressions, emotions, motions, and other implementations of the sort that an animatronic is to perform or represent. In short, the content projection enhances bulkier movement of the mechanical portions of the projection surface of the animatronic to generate effects not possible with conventional techniques.

In some embodiments, a position, orientation, or pose of the animatronic is tracked or otherwise identified using a combination of one or multiple tracking or position identification methods. In many instances, the orientation may be tracked in real-time to ensure alignment and accurate projection between the projected content and the mechanical movement of the projection surface. For example, the tracked pose of the animatronic is used by a real-time rendering engine to render a desired image (e.g., desired artistic content) to be projected onto the animatronic by one or more projectors based on the position (e.g., topography, deformation, pose) of the features of the projection surface. By helping to avoid misalignment between the content and the motion, the realism is enhanced, whereas misalignment will detract from the realism.

In various embodiments, the tracking may include internal tracking data (e.g., intrinsic data) that is generated by tracking mechanisms positioned internally in the animatronic and external tracking data (e.g., extrinsic data) that is generated by tracking mechanisms positioned externally from the animatronic. The internal tracking data may correspond to the movement and position of the mechanical elements used to deform the projection surface as well as the internal movement and position of the projection surface. The external tracking data may correspond to the movement and position of the projection surface as it is deformed (e.g., from an external perspective). In some examples, the internal tracking data may be compared to the external tracking data and further compared to the content projected onto the projection surface to ensure the alignment of the movement and deformation of the projection surface with the content that is projected onto it.

In various embodiments, a sensor fusion algorithm may be used to combine the internal tracking data and the external tracking data by associating a weight to the internal tracking data and the external tracking data. The output of the sensor fusion algorithm may be understood as combined tracking data that may be used to ensure the alignment of the movement and deformation of the projection surface with the content that is projected onto it. Note that the combined tracking data may have much less uncertainty than if the internal tracking data and the external tracking data are used individually as any deficiencies in the internal tracking data may be overcome by the external tracking data (and vice versa).

In some instances, a machine learning model or a similar algorithm may be used to predict a future position and future movement of the projection surface and the animatronic based on analyzing already collected internal tracking data and external tracking data. The predicted future position and/or future movement may be used to better align the content projected onto the projection surface and the mechanical movements deforming and modifying the projection surface.

In some cases, the internal tracking data and the external tracking data may be analyzed together to determine whether any portion of the animatronic is broken or wearing out. For example, if the projected content and the mechanical movement are continuously modified to be aligned, but the internal tracking data and the external tracking data are not aligned, it may be determined that a motor (e.g., or other mechanical element) that deforms the projection surface is broken or wearing out. In some examples, the system may indicate that said motor is broken or worn out to a user or technician. In some examples, the projected content and/or the mechanical movement may be modified to be compensated for the broken motor as to hide that the motor is broken (e.g., until a mechanic or user may fix the motor). The compensation may be understood as using other motors around the broken motor to produce the same mechanical movement, or adding more torque/force to the motor if it is worn out to produce the same mechanical movement. As a result, the broken and/or worn out motor may not be noticeable by those viewing the animatronic and content projected onto the animatronic due to the compensation.

In various embodiments, the alignment of the content projected onto the projection surface and the mechanical movements modifying the projection surface may be performed by a digital pipeline. For example, a position of the projection surface and the animatronic as a whole may be rendered based on the position determined from the internal tracking data and the external tracking data. Pixels corresponding to the projected content are digitally projected onto the projection surface and/or animatronic. This may be done at least 240 times a second. If the pixels digitally projected onto the rendered projection surface and/or animatronic are not aligned, the projected content and or the mechanical movement of the projection surface and/or animatronic may be modified based on the internal tracking data and/or the external tracking data to align the projected content with the mechanical movement. In some examples, once the internal tracking data and/or the external tracking data is used it may be marked as old data (e.g., used data) so that it is not used for current modification of the projected content or the mechanical movement.

As compared to conventional methods, the realistic appearance is enhanced by increased fidelity and detail of the animatronic. Further, the projected content contains more degrees of freedom than possible in traditional animatronics. In some embodiments, the animatronic may be animated more consistently compared to traditional animatronics as a number of artistic elements within the projected content, e.g., color, motion, smoothness, etc., will be the same even if the mechanical components or skins are changed over time (e.g., actuators slow or skin colors change). In some examples, the skins or other coverings defining the projection surfaces for the animatronics do not need to deform as much (e.g., can have a shorter/smaller range of motion) as compared with traditional animatronics. As a result, the lifespan of such skins and other coverings may last much longer as compared to traditional animatronics. Additionally, in some cases, special effects may be employed for the implementation of the animatronic that are not possible using traditional techniques, such as enabling animated figures to blush, cry, or be animated to perform any other special effects (VFXs) that can be projected.

In some embodiments, multiple considerations on designing the topography of the face of the animatronic (or any other part of the animatronic) may be introduced. For example, instead of using a traditional animatronic face with functions that move skin, in some embodiments, facial functions may be designed that morph the skin topography to serve as a projection surface. In some implementations, the projection surface is a continuous projection surface. For example, the mouth of the animatronic may not be a physical mouth aperture, but rather the face skin can stretch over the mouth aperture or recess (e.g., as a mouth bag), and the projected content may define the image of the inside of the mouth with teeth and a tongue. The mouth bag may move (e.g., via an actuator) to deform the topography of the projection surface to showcase the mouth and any motion and movement that may be performed by the mouth. The projection surface helps to ensure that the content has a surface onto which it can be projected. As another example, eyebrow functions of the animatronic may morph the topography of the skin of and around the eyebrows (e.g., push out the skin, slide the skin up/down, tilt the skin) to create an embossment in the shape of the eyebrow in the desired position (e.g., instead of traditionally attaching to the skin itself). In some examples, extra material may be included in the projection surface in areas where the projection surface may need to be extensively deformed to match an intended character or emotion (e.g., a longer nose, horns, or a defined larger chin).

Portions of the face of the animatronic that do not move may be given additional consideration. For example, traditional animatronics use large amounts of surface detailing in the face, however embodiments herein use a hybrid projection face with limited surface detailing. Traditional animatronics include certain details (e.g., molded areas of the covering) that may create deep creases and crevices in the face skin topography that would occlude light, e.g., create shadows or prevent accurate projection onto the surface. Additionally, in traditional animatronics, the more defined a facial detail is, the less flexible the facial detail is for a projection that needs to animate and change over the top of the facial detail. Embodiments herein include smooth projection surfaces on specific parts of the projection surface of the animatronic that will be needed for projection and parts that are sensitive to light occlusion. As a result, the animatronic may be flexible for dynamic projection content.

In some instances, a machine learning model may be trained with one or more feedback loops and process refinements to make decisions that impact surface projection topography that optimize smoothing of the projection surface of the animatronic and avoid casting shadows on the animatronic.

Embodiments herein may lower the design and fabrication costs of the mechanical face of the animatronic, as there are fewer mechanical functions (e.g., such as actuators) for the simplified face using the projection surface. Additionally, embodiments herein may lower the maintenance cost of the animatronic as there are fewer components that may break down. Moreover, in some embodiments, the design of the skin of the animatronic is a projection surface in that the skin may not include apertures, which traditionally define stress points that rip and tear over time, such as eye apertures or the corners of the mouth. Such a configuration helps to reduce wear and tear on the skin of the animatronic, increasing life span of the skin of the animatronic and the animatronic itself. Further, embodiments herein increase the viewing angle and realism of the animatronic as the projection surface may wrap around the animatronic and the proportions of the animatronic with the projection surface may remain the same. Accordingly, from the side or from the back, the animatronic may still look as the intended character/implementation, whereas traditional animatronics may look robotic and unnatural due to different surfaces, apertures, as one looks around a traditional animatronics (e.g., side and back views).

In some implementations, the animatronic may exist in a scene including set lighting. For example, animatronics may be placed in themed environments that are illuminated by theatrical lighting (e.g., ellipsoidal(s), follow-spot(s), Fresnel(s), PAR Can(s), floodlight(s), Cyc Light(s), strip light(s), gobos,) and special effect elements that include fiberoptics, projection, blacklight, and/or phosphorescent etcetera. The theatrical or scenic lighting may be used to illuminate the animatronics, sets and props so the users experiencing the animatronic can clearly see everything they are meant to see onstage (e.g., intended emotions and performed actions). However, in some cases, it may be that the environment is illuminated while the animatronic(s) are also illuminated. Note that the lighting of the animatronic is not exclusive, but rather a combination of both primary projection lighting and secondary scenic object lighting. For example, secondary scenic object lighting is light that bounces off scenic objects, resulting in unwanted illumination of the animatronics in the environment. The amount and type of reflected light may depend on the light saturation, hue and intensity, as well as the surface's texture or smoothness and other material intrinsic optical properties. Therefore, the primary projection lighting from the projection may take into account (e.g., when being generated) the lighting of the scene to seamlessly integrate and blend in as part of the environment.

In some embodiments, virtual lighting generated digitally in the rendering engine may be combined with practical theatrical lighting in the scene to achieve creative intent and seamlessly integrate the two different light sources onto the animatronic and the scene around the animatronic. A virtual material that accounts for the reflections of the secondary scenic lighting that may light the animatronics may be used. For example, this may be a virtual material that is dynamic to capture changes in the scene. The combination of the virtual lighting with the theatrical lighting may be achieved by virtually modeling the physical light environment into a rendering engine and by using a combination of both discrete lights, projected lighting, and high dynamic range image (HDRI) environment light captured from the scene to accurately model the scene.

A virtual figure may be positioned in a virtual lighting environment to render a projected image. As the animatronic moves or changes orientation through the physical space, the virtual figure is tracked and also moves through the virtual space. Accordingly, the lighting that interacts with the virtual material on the virtual figure changes, which is then rendered out through the projector and projected back onto the animatronic. This results in the animatronic reacting to the lighting in the same scene. Conversely, the lighting in the scene can change dynamically, and may be reflected and modeled accurately in the virtual environment, either through physical or digital triggers or sensors. This change in lighting may be displayed on the virtual figure that is rendered and projected back onto the physical figure. In some instances, micro lighting may be included to address orifice lighting needs to achieve creative intent. This lighting may be dynamic to blend the real world with the virtual world.

In some embodiments, the system for animating the animatronic may include animatronic tracking. For example, the system performance of the system may be based on the accuracy of the tracking. Faster tracking accuracy, speed, and reduced latency of the animatronics assist to ensure that the content is aligned and therefore more realistic. In some instances, tracking the dynamic poses of the animatronic includes using feedback data from the animatronic. The tracking of the dynamic poses of the animatronic includes using, for example, motor encoder positions, passive encoders, sensors, motor torques, currents, accelerations, velocities, various other types of encoders, rotaries, linear variable differential transformers (LVDTs), resolvers, etc. In many instances, the data is read and processed in real-time. The processing of the data may include computing joint positions and rotations, and reconstructing the kinematics model of the animatronic. As a result, the kinematic model calculates the resulting pose of the animatronic. The tracked pose is used by the rendering engine to synchronize and align the projected content onto the animatronic. The intrinsic tracking procedure includes an accurate alignment and fabrication of the physical animatronic to match the virtual model representation. Many embodiments may not need an external tracking system, instead relying on intrinsic tracking, allowing much faster feedback and processing speeds (e.g., many external tracking systems have a speed of about a couple hundred hertz, whereas intrinsic tracking used according to embodiments herein runs as fast as motor control systems (e.g., around a couple thousand hertz).

Additionally, in some embodiments, with external tracking related to inertial measurements, it may be that in many cases orientation data and positional data of an object may need to be acquired. To achieve a high accuracy of real-time rotary data per object for animatronic sync projection, intrinsic tracking with internal measurement units (IMUs) may be introduced. An IMU may track the X, Y, and Z direction of movement of the animatronic and/or the projection surface. Further the IMU may track the roll, pitch, yaw, and/or angular deflection of the animatronic and/or the projection surface. It should be understood that a high accuracy may be needed to achieve meaningful projection of real-time assets back to animatronic heads, bodies, and body parts.

In some instances, traditional animatronics exhibit mechanical inaccuracies due to build tolerances, mechanical slop, or backlash due to wear and tear. These inaccuracies cannot be captured by internal motors and encoders alone, and other measurements may be needed.

In some embodiments, a combination of intrinsic or camera-based tracking and IMU systems may be used. Such embodiments may achieve multiple data sources for position data and orientation data. As a result, this may allow the use of a broad selection of tracking systems beyond intrinsic tracking, such as camera-based tracking. In some instances, the system can deal with temporary occlusions, using the displacement information from the IMU as position indicator. It should be understood that animatronics experience wear and tear over time, which reduces the accuracy of the movements and projected content and can introduce downstream errors in tracking and alignment of the content. For example, movements not captured by motor encoders may not be tracked by intrinsic tracking. In some cases, this may occur because of mechanical backlash, play, or slop.

In some embodiments, IMUs can be added to select joints in the animatronic. Instead of using motor encoders to determine relative joint rotations, the IMU rotational values of specific joints may be used to determine joint rotations relative to ground. This can then be used in a similar manner to reconstruct the kinematics model of the animatronic, in order to ultimately determine the entire position and rotation pose of the animatronic.

Consider an example where the head of the animatronic is to be tracked, and the head is a three degrees of freedom (DOF) function driven by three different motors for each DOF. According to embodiments herein, one or more IMUs may be placed in the head and the orientation information of the IMUs can be deconstructed into Euler rotation angles to determine the rotation angle of each of the three motors.

In some embodiments, to capture mechanical inaccuracies of intrinsic tracking, extrinsic tracking may be used in combination with intrinsic tracking in a sensor fusion manner. Extrinsic tracking includes external cameras that capture the animatronic and optionally include markers, either passive or active, in order enhanced detection or calculation of the position of the object. In some examples, this may be referred to as “outside in tracking.” Extrinsic tracking can determine absolute position and rotation, but may have issues related to stability, noise, and speed. Intrinsic tracking can be fast and accurate. In many embodiments, combining the functionality of both intrinsic and extrinsic tracking can be helpful to enhance accuracy, speed, and cost. Sensor fusion algorithms can be used to combine sensor data from different sources (e.g., internal and external sources) so that the result has much less uncertainty than if these sources were used individually.

In some implementations, combining intrinsic tracking and extrinsic tracking may be achieved by using extrinsic tracking to determine the absolute position and rotation of a certain joint, and then using that joint as the base upon which to construct the kinematic chain using intrinsic tracking. This way, intelligent decisions may be made whether to use extrinsic tracking or intrinsic tracking on certain joints which may have some mechanical error. For example, extrinsic tracking may be used on joints that have slop and mechanical error, or drift and intrinsic tracking may be used on joints that are stiff, made of higher quality materials, or have less mechanical error.

Alternatively or additionally, extrinsic tracking may be used not directly on the surfaces of the animatronic itself, but on a separate mechanical part attached to the animatronic. In some instances, it is not possible to put tracking markers on the animatronic itself because of various reasons, such as, hiding the trackers from the view of users experiencing the animatronic, clothing of the animatronic getting in the way, or other mechanical feasibility issues.

In some cases, extrinsic tracking may be used by swapping where the cameras and the markers are attached. For example, the camera may be placed inside the head of the animatronic and the markers may be placed out in the environment around the animatronic. Then, the relative position of the camera to the markers may be used (e.g., inverting the transformation) to determine the pose of the head of the animatronic. This may also be referred to as “inside out tracking,” as opposed to the aforementioned “outside in tracking.”

In some embodiments, radio frequency tracking may be used to track the pose of animatronics. Radio frequency tags may be placed on each joint, and radio frequency sensors may be placed in the environment. The pose of the animatronic may be determined from the position and rotation data of each of the tags.

In some embodiments, electromagnetic tracking may be used to track the pose of the animatronic. Electromagnetic receivers can be placed on each joint of the animatronic, and the electromagnetic transmitter may be placed in the environment. The pose of the animatronic may be determined from the position and rotation data of each of the electromagnetic receivers.

In some embodiments, light detection and ranging (LiDAR) tracking may be used to find the animatronic's head's translation and orientation using, for example, laser pulses and measuring the time for object projection. In some cases, one or more single-beam LiDAR sensors may be mounted on the back half of the animatronic's head. A lookup table may be used correlating the reported distance data(s) to animatronic's head pose. For example, when a first LiDAR sensor reads 1.072 m and a second LiDAR sensor reads 1.605 m, the head is at a known XYZ position and a known yaw pitch roll. In some cases, LiDAR may be practically viable for a small range of motion. If the lookup table has redundancies, these can be resolved by proximity.

In some other cases, to avoid needing to know where the head of the animatronic is, two or more “sniper spotter” LiDAR systems may be used. Such systems use high-Hz MicroElectroMechanical system (MEMS) projectors and high-Hz cameras (that can see both visible and infrared (IR)) to feed a control loop that attempts to align the visible projection to two or more IR-emitting key-points on the face. For example, a camera may see that the projected nose tip is incorrectly a certain distance left of the IR nose point. This error is fed into a control loop that corrects such error. Multiple reference points are used to achieve rotation/warp. Additionally, distance is never calculated or known by any part of the system. Rather, the system tries to keep two images (one visible, one IR) in alignment constantly. LiDAR can also be used to create a point cloud of a certain part of the figure, such as the face, which can then be registered against another predetermined known point cloud of the same part. This registration can then be used to determine the pose of that part of the animatronic.

In some embodiments, structured light scanning can be used to create a point cloud of a certain part of the animatronic, such as the face, which can be registered against another predetermined known point cloud of the same part. This registration can then be used to determine the pose of that part of the animatronic.

In some embodiments, IR activated coating pigments applied to a projected surface that exhibit, for example, IR down conversion, IR up conversion, anti-stokes shift, or black visible IR (e.g., black or clear) may be used to create markers for use in camera-based tracking. For example, such methods may shift/convert wavelength emission for measuring to generate various positional and movement data. In some cases, an up or down conversion coating may be used in a dot pattern and the system may initiate an up down fluorescence shift with an excitation source. Accordingly, a camera may capture such pattern and use it for tracking. In some other cases, an up or down conversion coating may be used in a unique fiducial marker (e.g., an AprilTag pattern), and the system may initiate an up down fluorescence shift with an excitation source. Accordingly, a camera may capture such pattern and use it for tracking. IR coatings are pigments not visible under visible light, but are visible under infrared light. Such paint (e.g., IR coatings) can be used to paint markers for existing off-the-shelf extrinsic tracking systems, or it can be used to paint fiducial markers for IR cameras to look at and solve for positions. These paints (e.g., IR coatings) can be applied to each joint of the animatronic to determine the pose of the animatronic.

In some embodiments, fiber optic may be used for animatronic pivot tracking. For example, shape forming optical elements or direct shape forming optical shapes may be applied on the fiber optics. Accordingly, these shapes may be applied onto the front of the projected surface for external camera tracking to compute translation and orientation of the animatronic for tracking. In some examples, small fiber optics carrying IR light can be used on a certain part of the animatronic, such as the face. These fiber optics are too small to be noticed by users experiencing the animatronic and the IR wavelength is invisible, so they can be used directly on the same surface upon which content is projected on the animatronic.

In some embodiments, facial recognition machine learning models may be used for animatronic tracking. For example, a camera may be set up and the camera and the image feed of the camera may be sent to an existing off-the-shelf facial recognition model to recognize the face of the animatronic and provide the system with the estimated pose of the face of the animatronic. This pose can then be used by a rendering engine to transform the content to project back onto the animatronic's face. In some cases, a discriminative shape regression method may be applied to locate the facial feature points on the 2D image and may fuse the 2D data with a 3D face model using, for example, an extended Kalman filter to yield 3D facial movement information with IMU or IR up conversion tagging.

In some embodiments, a machine learning model may be developed and introduced for animatronic head pose estimation for relative front face animatronic orientation and position with respect to an external camera. In some cases, wavelet features on camera captured images and principal component analysis may be used to determine an orientation of an object of interest of the animatronic (e.g., head, arm, leg, wrist, elbow, hand, neck, shoulders, etc.) with principal component analysis coefficients. Then, a Kalman filter may be applied on captured frames. In some other cases, a model base approach based on perspective projection may be used. Geometric features such as eyes, ears, or a nose may be used to track animatronic facial landmarks. In yet some other cases, a combination of wavelet features and the model based approach based on perspective projection may be used. For example, a 3D deformable shape model may be learned using principal component analysis (PCA) methods. Then, a linear combination of an average shape may be applied. In some examples, one or more cameras may be set up in the environment to look at the animatronic. A series of pictures may be taken of the animatronic in different poses, along with recording the 3D position and rotation data of each joint of those poses. This data may be used to train a machine learning model, by providing images of a certain part of the animatronic, such as the face, arms, legs, shoulders, neck, etc., along with the corresponding 3D position and rotation. The result would be a machine learning model that outputs a 3D position and rotation of a part of the animatronic given a camera image from a certain viewpoint.

In some implementations, in addition to standard red green blue (RGB) cameras, depth cameras may be used to augment the received data. The data may be used to solve for the pose of a part or the entire animatronic.

In some embodiments, predetermined geometric shapes placed on the animatronic may be tracked using, for example, a generalized HoughGuil transform to determine the position and orientation of an animatronic or an animatronic's body parts. The tracking of predetermined geometric shapes may be used in combination with IR up conversion, IMU, intrinsic tracking, extrinsic tracking, PCA, Kalman filter, weak perspective procedures, or other procedures for tracking the animatronic discussed herein. In some instances, instead of trying to track and solve for an arbitrary and complex shape that is a part of the animatronic, such as the face, a simpler, known, predetermined, geometric shape may be attached to the part (or embedded in the part) of the animatronic, which would not be visible to the users experiencing the animatronic, such as on the back of the head of the animatronic. The known predetermined shape may be seen by cameras, and the resulting camera image can be used to solve for its 3D pose using simple image processing algorithms. For example, incorporating strips dipped with IR reflective material can be molded into to an intended skin that would hold an intrinsic predetermined shape that may be only visible by IR camera. This will allow for a front projection surface or a secondary back projection surface. To determine its orientation and position, knowing the camera intrinsic parameters (e.g., focal length, optical center) and extrinsic parameters, an edge detection (e.g., Canny edge detector) may be applied to a captured image and then a corner detection algorithm (e.g., a Harris algorithm) may be applied to the capture image. The center of the shape in the capture image may be calculated and the shapes orientation may be determined. Then, intrinsic and extrinsic tracking and object 3D real world referenced coordinates from a mechanical model may be used to reference orientation of the object of interest of the animatronic. In various examples, it may be that the predetermined shapes may be visible only in the ultraviolet (UV) spectrum.

It should be understood that the generalized HoughGuil transform discussed herein may be used to detect arbitrary, known shapes in an image, even when rotated, translated, or partially occluded, by using a model-based lookup table that maps edge orientations to possible shape locations. Accordingly, the generalized HoughGuil transform may be used locate a known geometric shape attached to the animatronic so that the position of the animatronic may be determined.

In some implementations, radar or sonar may be utilized as means of tracking each joint of the animatronic (or the animatronic as a whole) to determine the pose of the animatronic.

In some embodiments, light emitting sources such as, but not limited to, light-emitting diodes (LED) assemblies, UV activated emitters, IR activated emitters, electroluminescent panels, and fiber optics, may be positioned onto the animatronic or embedded into the animatronic as to the track the animatronic and its movements. Sensors may detect light or other waves (e.g., IR and/or UV) and calculate the position and/or movement of the animatronic based on the location of the light sources on/in the animatronic.

In some embodiments, the animatronic is tracked in real-time. As such, the lower the latency of the system, the more accurate the results of the projection are as to provide the illusion that the projection appears stuck or painted onto the animatronic surface. However, the processing, rendering, and projection may take time, introducing some delay and/or latency. However, the delay/latency may be compensated by prediction. For example, in some embodiments, the time it takes for the system to process a single frame, end-to-end, from tracking to projection may be measured. The motion and the pose of the figure may be predicted into the future for that exact time. The projection is rendered to the predicted pose of the animatronic, so that by the time the system is done processing, the projection ends up to where the animatronic would be in time. In some cases, the latency of the system is within tens of milliseconds, so the prediction does not need to be very far into the future. At this relatively small timescale, real-world objects obeying the laws of physics tend to behave in a relatively smooth and continuous manner, so physics simulations may be used to accurately predict the motions.

In some tracking methods discussed herein, an accurate kinematic model of the animatronic was created. However, such predictions methods may be used in combination with the tracking methods. For example, a dynamic model of the animatronic may be created with all the physical properties such as mass, center-of-mass, etc. The dynamics properties of the physical figure may be measured and calculated in real-time, such as velocity, acceleration, torques, and more. Then, this information may be combined to run a physics simulation of the animatronic to predict the pose of the animatronic into the near future. Moreover, in cases where the animatronic performs a known portion of the content (e.g., movement), content command information may also be used as additional input to the physics simulation to improve the prediction results.

Alternatively or additionally, a machine learning model may be trained to perform motion prediction. For example, the machine learning model approach discussed herein may be expanded and trained to perform motion prediction. In addition to providing the static pose information, the entire kinematic and dynamic model of the figure may be provided to the model, along with the current dynamic information such as velocity and acceleration with respect to time. The result of the machine learning model is a time-based machine learning model that can predict where the pose of the figure would be in the specified time in the future given the current real-time dynamic information.

It should be understood that any of the tracking procedures discussed herein may be used independently or combined with one another to track the position and/or rotation of a part of the animatronic or to track or calculate the overall pose of the animatronic.

Note that embodiments herein allow for the continuous aligning of the movement of the content projected onto the animatronic with the movement of the projection surface of the animatronic even if an actuator or a motor of the animatronic fails/breaks. For example, the tracking procedures discussed herein may still provide data corresponding to the animatronic to the controller if an actuator breaks, allowing the controller to align the projected content with the animatronic (with the broken actuator). As a result, the animatronic with the broken actuator or motor is less noticeable.

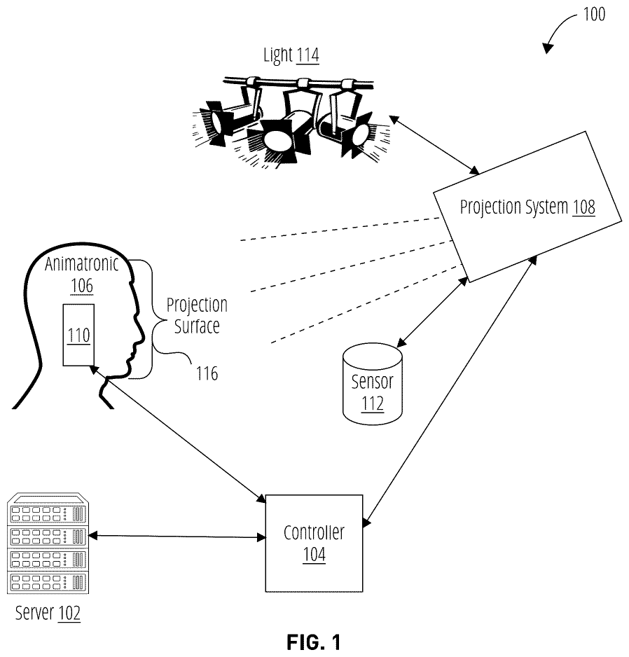

Turning to the figures, FIG. 1 illustrates a simplified schematic of a system 100 for performing dynamic projection mapping onto animatronics in real-time.

The system 100 for performing dynamic projection mapping onto animatronics includes a server 102, a controller 104, an animatronic 106 (including an actuator 110), a projection system 108, one or more sensors (hereinafter “sensor”) 112, and one or more (hereinafter “lights”) 114.

The animatronic 106 may include one or more projection surfaces 116 onto which content may be projected. The projection surface 116 may be a surface covering at least a portion of the animatronic, e.g., a head of the animatronic 106 or any other part of the animatronic106 desired to be animated. For example, the projection surface 116 may be a skin of the animatronic. In some implementations, the projection surface 116 (e.g., the skin of the animatronic) may be continuous such that the projection surface 116 does not include any apertures therein, e.g., a unitary structure. In other implementations, the projection surface 116 may be non-continuous. The projection surface 116 may cover multiple moving surfaces of the animatronic 106. The animatronic 106 may receive mechanical inputs from the controller 104 and performed by one or more actuators (hereinafter “actuator”) 110 as to change the topography or otherwise deform the projection surface 116. This may be achieved using the actuator 110, or by using motors, or any other mechanical elements connected to the projection surface 116 of the animatronic 106. In many embodiments, the actuator 110 is positioned beneath or behind the projection surface 116 to move the projection surface 116 from behind and acts to deform or create ridges, recesses, or the like to the projection surface 116. Additionally, the projection system 108 may project content onto the projection surface 116 of the animatronic 106. In some examples, a tracking mechanism may be coupled to the actuator 110 to track the movement and position of the actuator 110 for the alignment of projected content and mechanical movement of the actuator 110.

The projection system 108 may receive data from the controller 104. The data corresponds to content that is to be projected onto the animatronic 106. The projection system 108 may project the content onto the animatronic 106. The projection system 108 may include a projector (or more than one projector) having a lens system configured to control the image quality and/or magnification. The projection system 108 may optionally include one or more mirrors and/or one or more filters. In some cases, the projection system 108 may adjust what content is being projected onto the animatronic 106 or how the content is being projected onto the animatronic 106 to better align the projection of the content with the projection surface 116 of the animatronic 106. This may be achieved through the use of the sensors 112 that may collect data pertaining to the animatronic 106 and lights 114 that may illuminate the animatronic 106. The collected data may be understood as data collected from tracking the animatronic 106 via the sensors 112 using any of the tracking procedures discussed herein. Note that the projection system 108 may be made up of one or more projectors and various different projectors (e.g., light, lasers, video, environmental projectors, etc.) that may be used in combination to achieve the projection of content onto the animatronic 106.

In some cases, the controller 104 may receive data from the animatronic 106 (e.g., topography, position, orientation, movement data) and from the projection system 108 (e.g., content based data). Additionally, the controller 104 may receive data collected by the sensors 112 corresponding to the animatronic 106 (e.g., data corresponding to tracking the animatronic 106). The controller 104 may use such data (e.g., feedback) to align the projection surface 116 of the animatronic 106 and the content being projected by the projection system 108. Additionally, the controller 104 may transmit such data received from the animatronic 106 and the projection system 108 to the server 102 for storage or for use in future implementations or, in some cases, model training. The controller 104 may receive, from the server 102, previous data obtained from the animatronic 106 and the projection system 108 to better align the projection surface 116 of the animatronic 106 and the content being projected by the projection system 108. The controller 104 may transmit mechanical movements to the animatronic 106 to be performed by the actuator 110 (or actuators 110) that may be used to adjust the topography of the projection surface 116 of the animatronic 106. The controller 104 may transmit content to the projection system 108 to be projected by the projection system 108 onto the projection surface 116 of the animatronic 106. Note that the mechanical movement parameters to adjust the topography of the projection surface 116 of the animatronic 106 may be inputted into the controller 104 by a user. Additionally, the content that is to be projected onto the animatronic 106 by the projection system 108 may be inputted into the controller 104 by a user or modified by the user to better align with the actuators 110 of the animatronic 106. The modification may take the form of modifying the timing of the content, modifying the lighting intensity and colors of the content, and/or modifying intended emotions/movements to be performed by the animatronic 106 via the actuator 110.

The server 102 may transmit stored data to the controller 104 and/or receive data from the controller 104 for storage corresponding to the animatronic 106 (e.g., topography, position, orientation, movement data) and to the projection system 108 (e.g., content based data). In some examples, this data may be used for future implementations and/or model training.

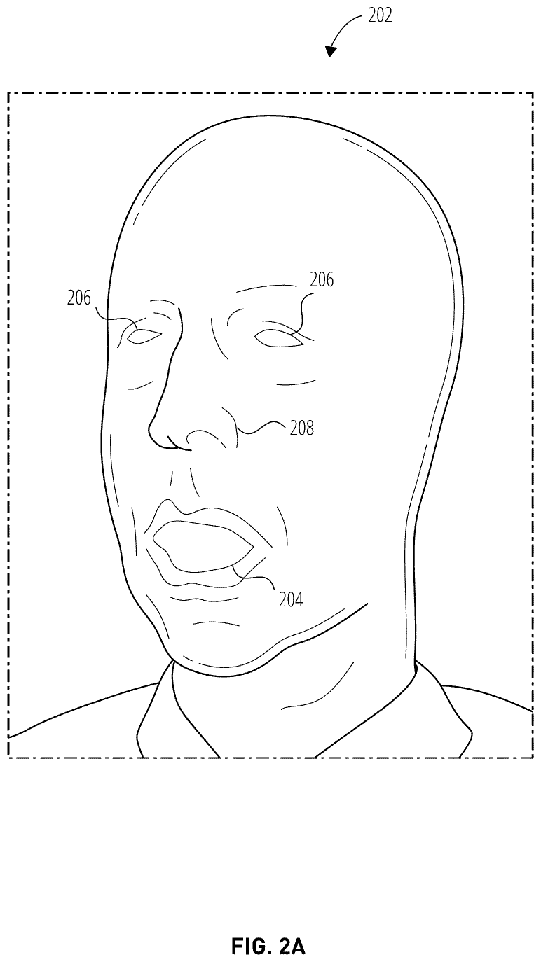

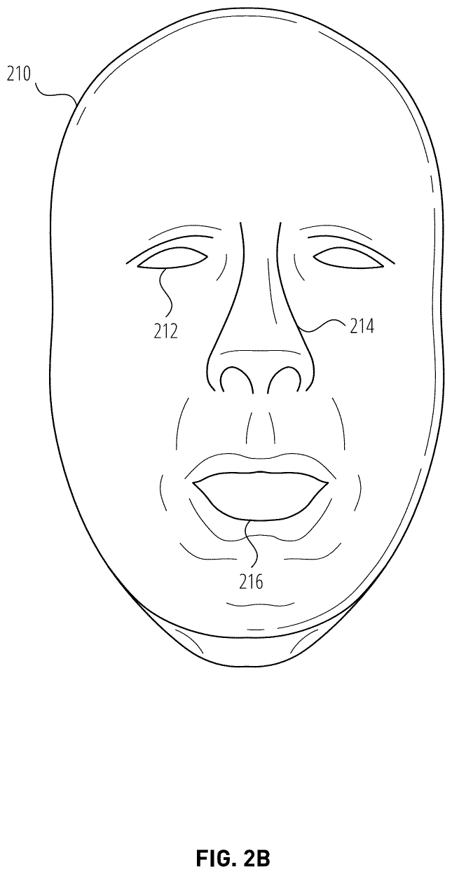

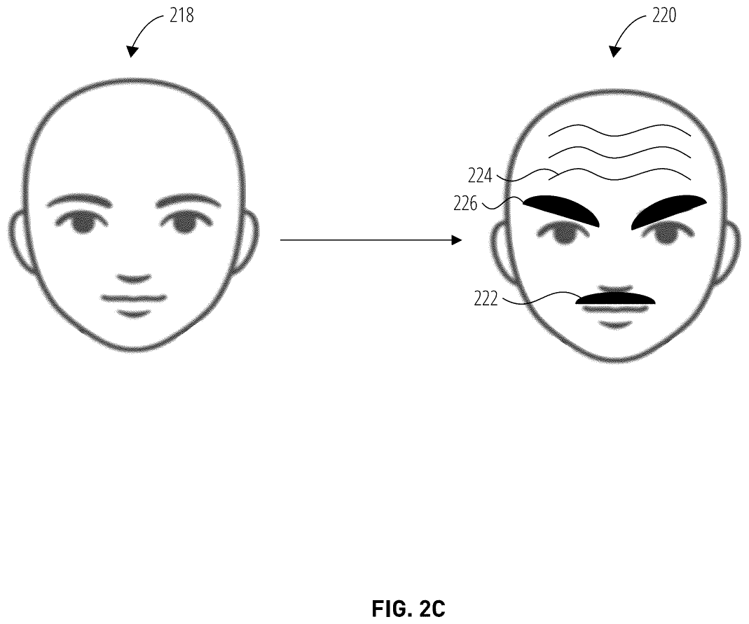

FIG. 2A illustrates an example animatronic with a projection surface 202 positioned over a robotic structure of the animatronic, for example, the head of the animatronic (such as the projection surface 116 positioned over the animatronic 106 illustrated in FIG. 1). In examples in which the projection surface 202 is continuous, the projection surface 202 may include various shallow recesses or depressions resembling features such as a shallow recess for a mouth 204, shallow recesses for eyes 206, and a shallow recess for a nose 208. The shallow recesses of the mouth 204, the eyes 206, and the nose 208 are continuous with no apertures, tears, or openings as compared to deep recesses with apertures and openings used in current animatronic systems. The shallow recesses of the mouth 204, the eyes 206, and the nose 208 may allow for topographical mechanical changes on the surface and the projection surface 202. For example, the shallow recesses form slack in the projection surface 202 that allows the projection surface 202 to be more readily formed into various shapes, e.g., pulled back to define a cavity for a mouth or pushed forward to define eyebrows or the like. The amount of excess or slack for the projection surface 202 depends on the desired features to be formed with the surface, as well as the flexibility of the projection surface 202 material. The projection surface 202 material may include one or a combination of silicon, neoprene, latex, cloth, and/or elastomers (e.g., self-healing or liquid crystal). In examples in which the projection surface 202 is non-continuous, one or more recesses described above may be replaced with an aperture, tear, or other opening.

In some instances, the actuators (or other mechanical elements) may be used to manipulate the projection surface 202 to include/display various shallow recess resembling features such as the shallow recess for the mouth 204, shallow recesses for the eyes 206, and the shallow recess for the nose 208. Many conventional animatronics will have separate skin pieces that form a portion of the animatronic and will have openings, such as the mouth, ears, eyes, to allow other secondary elements to be inserted and used to form the animatronic effect. On the contrary, the present embodiments allow a single element, e.g., the projection surface 202, to be sufficiently manipulated to form these different elements and can change between convex and concave shapes to easily transform into different aesthetic features.

FIG. 2B illustrates an example of a projection surface 210 of an animatronic modified to align with content projected onto it.

In various embodiments, topographical mechanical changes (made by mechanical elements such as motors and actuators) on the surface of the projection surface 210 allows the projection surface 210 to be formed into various shapes. For example, in implementations where the projection surface 210 is continuous, the projection surface 210 may be pulled back to form eyes 212, the projection surface 210 may be pushed out to form a nose 214, and the projection surface 210 may be pulled back to form a mouth 216. The topographical mechanical changes may be achieved by activating actuators (e.g., such as the actuator 110 illustrated in FIG. 1) that are attached to the projection surface 210. It should be understood that the actuator is attached to the projection surface 210 behind the projection surface 210 (e.g., in the animatronic) and manipulates the projection surface 210 by either moving the shallow recesses of the projection surface 210 or the projection surface 210. For example, an actuator may push, pull and stretch the shallow recess corresponding to the mouth 216, mimicking movement of a mouth. In another example, an actuator may push the middle of the shallow recess corresponding to the mouth 216 to mimic a tongue. Note that one or more actuators (or other mechanical elements) may be connected (coupled) to each shallow recess, or each portion of the projection surface 210 to manipulate the shallow recesses themselves and/or to manipulate the projection surface 210 as a whole.

FIG. 2C illustrates an example of a projection surface 218 of an animatronic and a projection surface 220 of an animatronic modified to align with content projected onto it.

In some embodiments, an animatronic may include a projection surface 218, such as a blank or content free surface, with minimal texture (e.g., similar to a projection surface) where content is to be displayed/projected on. This may be the head of the animatronic or any other body part of the animatronic where content is to be displayed/projected onto. For example, the projection surface 218 may be wrapped around a structure forming a face of the animatronic and may include basic simplistic facial details, such as simplistic mouth, eyes, nose and eyebrow impressions. Note that in implementations where the projection surface 218 is continuous, the projection surface 218 has no apertures, openings, or tears in it (including in areas of facial details such as the mouth, eyes, nose, ears and hair), as it is a continuous surface and extends over the mouth aperture to cover the aperture in the animatronic shell (in embodiments where there is such an aperture).

The projection surface 218 wraps fully or in part over a structure that includes actuator(s) (e.g., actuator 110) or any other mechanical elements to move the projection surface 218. For example, the actuator(s) may move, deform, morph, and/or stretch the projection surface 218 over the structure. Additionally, the actuator(s) may be configured to move, deform, morph, and/or stretch the projection surface 218 over the structure. Note that the number, configuration, and position of the actuator(s) and structure may depend on the desired content and emotion to be performed/portrayed by the animatronic.

In some embodiments, actuators, motors, or any other mechanical elements discussed herein may adjust and/or change the topography of the projection surface 218 to a manipulated projection surface (hereinafter “projection surface”) 220, e.g., manipulated by moving or deforming the surface. For example, the projection surface 218 may be manipulated to align with the content to be projected onto the projection surface 220 and to enhance the movement effect, animating the projection surface 220.

Additionally, content may be projected onto the projection surface 220 (with an adjusted matching topography) as to animate the projection surface 220 of the animatronic. For example, the projection surface 220 of FIG. 2C is animated (topography changed and projected onto) to align with content that projects a mustache 222, wrinkles 224, and eyebrows 226 onto the projection surface 220. The mustache 222, wrinkles 224, and eyebrows 226 may move corresponding to the desired content of the animatronic (e.g., move via the actuators). It should be understood that the projection surface 220 may be animated to showcase a multitude of human or non-human facial features, expressions, emotions, motions, and other content of the sort that an animatronic is to perform or look like.

In some instances, a controller such as the controller 104 illustrated in FIG. 1 may receive data corresponding to the change in topography of the projection surface 218 and/or projection surface 220 (or data corresponding to the projection surface 220 such as tracking data) and receive data corresponding to the content projected onto the projection surface 220 (e.g., the mustache 222, the wrinkles 224, and the eyebrows 226). The controller may analyze the received data to align the movement of the actuators manipulating the projection surface 220 with the content being projected onto the projection surface 220. The controller may continuously analyze the received data to continuously align the movement of the actuators manipulating the projection surface 220 with the content being projected onto the projection surface 220.

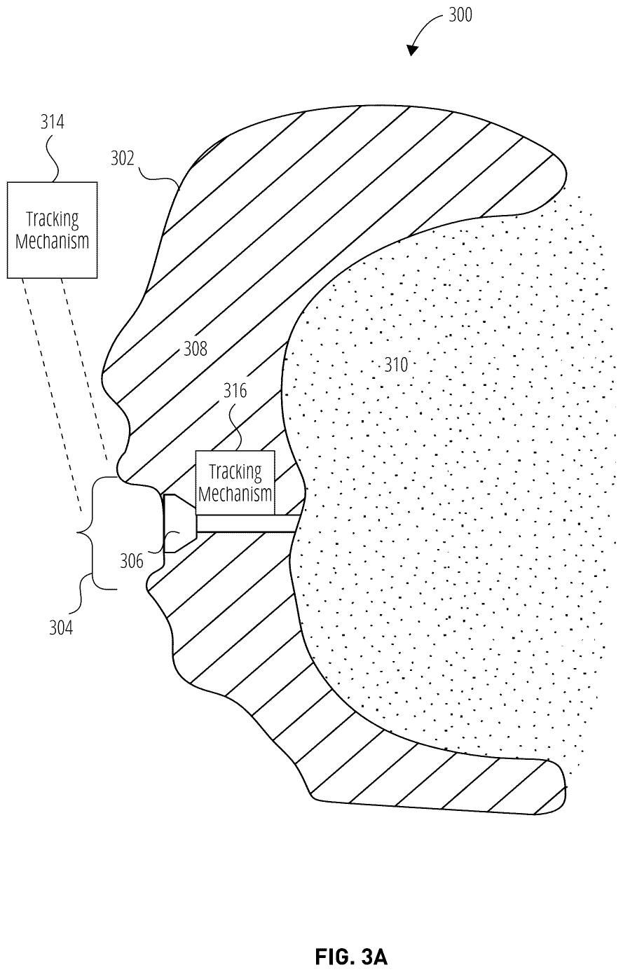

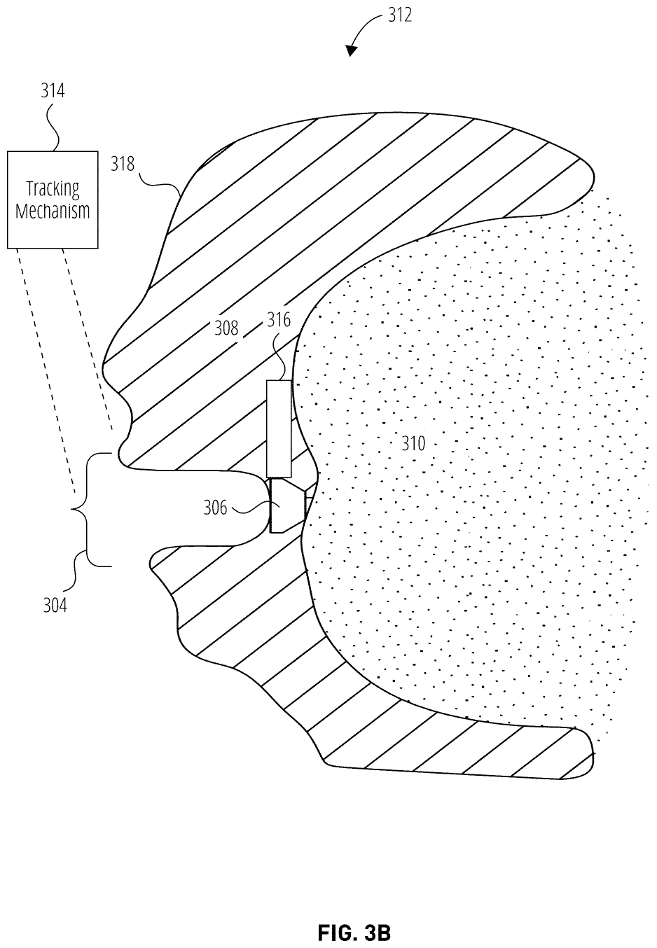

FIG. 3A illustrates a cross section side view 300 of a 302 with an actuator 306 that is at rest.

The cross section side view 300 is a view of a cross section taken down the middle of the projection surface 202 illustrated in FIG. 2A with the cross section side view 300 of the projection surface 202 facing to the left of the figure.

By way of example, the 302 is coupled to a shell 310 (illustrated with a dot pattern) of an animatronic, as discussed herein. Between the 302 and the shell 310 is space 308 (illustrated with crosshatching) where the 302 may be deformed into (e.g., pulled back into) using an actuator or other mechanical elements discussed herein, allowing an animatronic with the 302 to showcase an emotion or content. The illustrated 302 includes an actuator 306 that is coupled to a mouth recess 304, as discussed herein. The actuator 306 is at rest (e.g., not activated), not pulling or morphing the skin corresponding to the mouth recess 304 of the 302. Note that the mouth recess 304 is not accentuated or overly morphed while the actuator 306 is at rest (e.g., not activated).

A first tracking mechanism 316 is coupled to (e.g., mechanically secured, adhesively connected, or the like) the actuator 306 and may track the movement of the actuator 306 to generate internal tracking data. The internal tracking data may correspond to internal movements and positions of the actuator 306 and how the 302 internally moves via the actuator 306. It should be understood that the first tracking mechanism 316 is positioned internally in the animatronic (e.g., in the space 308, or alternatively in the shell 310) and that the first tracking mechanism 316 may take the form of any of the internal tracking mechanism discussed herein (e.g., IMU or encoder). As the illustrated actuator 306 is at rest in FIG. 3A, the first tracking mechanism 316 may be generating internal tracking data that corresponds to an actuator 306 at rest (e.g., acceleration of zero). However, the first tracking mechanism 316 may still track the position of the actuator 306 even while the actuator 306 is at rest.

A second tracking mechanism 314 may be positioned externally from the animatronic (e.g., in the environment of the animatronic). For example, the second tracking mechanism 314 may be coupled to an element of the environment around the animatronic such as a scenic element (as to hide the second tracking mechanism 314 from being visible), a track element that the animatronic is coupled to (e.g., travels along), the projection system such as the projection system 108 illustrated in FIG. 1, a light system such as the light 114 illustrated in FIG. 1, or any general structural element in the environment of the animatronic. The second tracking mechanism 314 may generate external tracking data corresponding to how the 302 has deformed/moved from the external perspective. The second tracking mechanism 314 may take the form of any of the external tracking mechanism discussed herein (e.g., a camera, sensor (such as sensor 112), radar, marker reader, etc.). In the illustrated example, the second tracking mechanism 314 may track the position of the mouth recess 304, but may generate external tracking data corresponding to zero movement of the mouth recess 304 (e.g., acceleration is zero) as the actuator 306 is at rest and the mouth recess 304 is not moving.

In some cases, the internal tracking data generated by the first tracking mechanism 316 and the external tracking data generated by the second tracking mechanism 314 may be used in combination with each other or independently from each other to ensure the alignment of the movement of the actuator 306 with content that is projected onto the 302.

While a single first tracking mechanism 316 and a single second tracking mechanism 314 are illustrated, it should be understood that multiple tracking mechanisms may be positioned internally in the animatronic and used to generate internal tracking data. Likewise, multiple tracking mechanisms may be positioned externally from the animatronic and may be used to generate external tracking data.

FIG. 3B illustrates a cross section side view 312 of a morphed projection surface with an activated actuator 306. The morphed projection surface 318 is a continuous projection surface.

The cross section side view 312 is a view of a cross section taken down the middle of the projection surface 210 illustrated in FIG. 2B with the cross section side view 312 of the projection surface 210 facing to the left of the figure.

By way of example, the morphed projection surface 318 is coupled to a shell 310 (illustrated with a dot pattern) of an animatronic, as discussed herein. Between the morphed projection surface 318 and the shell 310 is space 308 (illustrated with crosshatching) where the morphed projection surface 318 is deformed into using an actuator or other mechanical elements discussed herein. For example, the skin corresponding to the mouth recess 304 of the morphed projection surface 318 is being pulled back into the space 308 between the morphed projection surface 318 and the shell 310 by an actuator 306 that is activated. As a result, the mouth recess 304 is accentuated and morphed to look like a mouth. Note that the mouth recess 304 may be continuously morphed by the actuator 306 to animate the mouth recess 304 to perform content such as talking, eating, singing, etc.

The first tracking mechanism 316 may generate internal tracking data corresponding to the movement of the actuator 306 (e.g., a positive acceleration value) and the new position of the actuator 306 after it moves from the position illustrated in FIG. 3A to the position illustrated in FIG. 3B. Additionally, the second tracking mechanism 314 may generate external tracking data corresponding to the external movement of the morphed projection surface 318 and the mouth recess 304 (e.g., a positive acceleration value) and the new position of the morphed projection surface 318 and the mouth recess 304.

The internal tracking data generated by the first tracking mechanism 316 and/or the external tracking data generated by the second tracking mechanism 314 may be used in combination to ensure the alignment of the movement of the actuator 306 with content that is projected onto the morphed projection surface 318. For example, the movement of the actuator 306 may be modified to move sooner as it may be lagging compared to the content projected onto the morphed projection surface 318. The movement of the actuator 306 may be modified to have more force or have more torque as it may be determined based on the internal tracking data and the external tracking data that the actuator 306 may be wearing down (or that more force or torque is needed to deform the morphed projection surface 318). It may be that the movement of the actuator 306 may be eliminated if it is determined that a different actuator (or a combination of different actuators) may achieve a visually better looking deformation of the morphed projection surface 318 that may be better aligned with the projected content.

While the mouth recess 304 of the morphed projection surface 318 is illustrated, it should be understood that mechanical elements discussed herein may be used to morph any portion of the projection surface by either pulling skin of the projection surface into the space 308 between the projection surface and the shell 310 or by pushing excess skin out of the space 308 between the projection surface and the shell 310. This pulling and pushing of the projection surface may allow for the showcasing of an intended emotion or content on the animatronic with the projection surface.

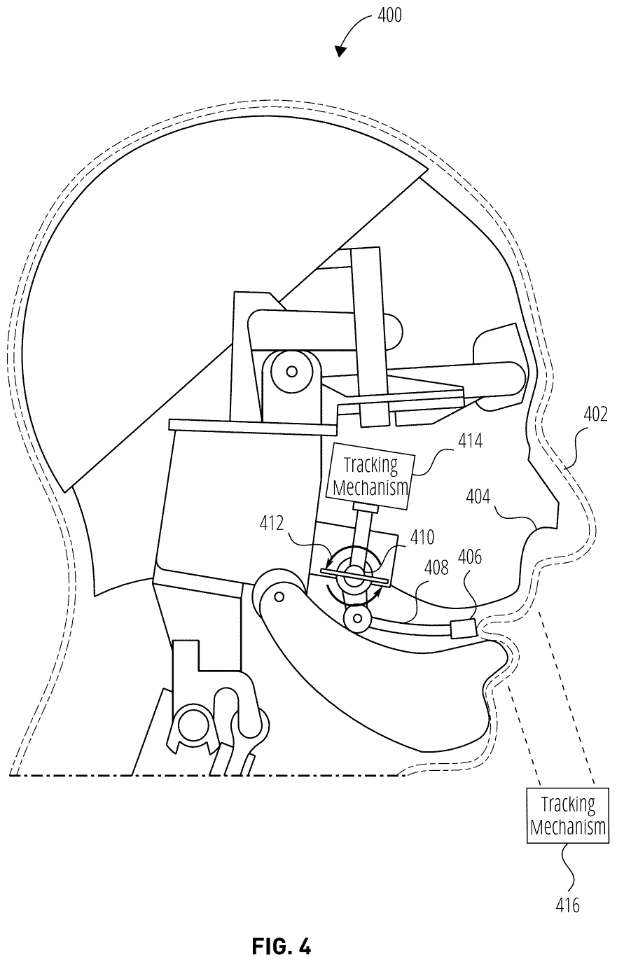

FIG. 4 illustrates a cross section side view 400 of a projection surface 402 with a modified topography.

The cross section side view 400 is a view of a cross section taken down the middle of the projection surface 202 illustrated in FIG. 2A with the cross section side view 400 of the projection surface 210 facing to the left of the figure.

In various embodiments, the projection surface 402 is coupled to (e.g., mechanically secured, adhesively connected, or the like) to a shell 404 of the animatronic. The projection surface 402 may be a continuous projection surface. Additionally, a mouth portion of the projection surface 402 is coupled or connected to a mechanical connection 406 that selectively varies the topography of the mouth portion. The mechanical connection 406 is coupled to a link 408, and the link 408 is coupled to a motor 410. As the motor 410 turns, the mechanical connection 406 coupled to the projection surface 402 may move via the link 408. For example, as the motor 410 turns in a first direction (e.g., clockwise or a counterclockwise direction 412), the mechanical connection 406 pulls, via the link 408, the mouth portion of the projection surface 402 inwardly (e.g., towards the motor 410) into the shell 404, such as to create a recess along the topography of the projection surface 402. In another example, as the motor 410 turns in a second direction (e.g., clockwise or the counterclockwise direction 412), the mechanical connection 406 pushes, via the link 408, the mouth portion of the projection surface 402 outwardly (e.g., away from the motor 410, out of the shell 404, etc.), such as to reduce the recess along the topography of the projection surface 402. Turning the motor 410 in the second direction may result in the mouth portion returning to the starting/resting position, or protruding out of the shell 404. The movement of the motor 410 modifies the mouth portion of the projection surface 402, allowing the mouth to move and mimic certain intended emotions (e.g., sad, happy, mad, etc.) and intended motions (e.g., talking, yelling, yawning, smiling, eating, etc.). The selective variation of the topography of the projection surface of the animatronic and the mechanical structure behind the projection surface 402 is further detailed in U.S. Non-Provisional Patent Application Ser. No. 19/407,596 filed on Dec. 3, 2025, and titled “DYNAMIC MECHANICAL SKIN STRUCTURES FOR ANIMATRONIC FIGURES,” which is herein incorporated by reference in its entirety.

A first tracking mechanism 414 may be positioned internally in the shell 404 to generate internal tracking data. For example, the first tracking mechanism 414 may track the movement of the motor 410, the link 408, the mechanical connection 406, and the internal movement of the projection surface 402. Additionally, the first tracking mechanism 414 may track a position of the motor 410, the link 408, the mechanical connection 406, and the internal movement of the projection surface 402.The first tracking mechanism 414 may take the form of an IMU or an encoder, etc. A second tracking mechanism 416 may be positioned externally to the shell 404 (e.g., external to the animatronic) to generate external tracking data. For example, the second tracking mechanism 416 may track the external movement of the projection surface 402. The second tracking mechanism 416 may take the form of a camera, sensor, radar, marker reader, etc.

In some examples, the internal tracking data generated by the first tracking mechanism 414 and the external tracking data generated by the second tracking mechanism 416 may be used to modify the movement of the motor 410 to better align (e.g., spatially and temporally) the movement of the mouth due to its coupling to the mechanical connection 406 and therefore the motor 410 via the link 408 with content that is projected onto the projection surface 402.

In some instances, the mouth portion of the projection surface 402 may be understood as a mouth bag that, when moved and/or modified by the movement of the motor 410, may deform the topography of the projection surface 402 to showcase a mouth and any motion and movement that may be performed by the mouth. In these examples, the mechanical action (e.g., forces) exerted by the mechanical coupling acts to change the topographical shape of the projection surface 402, such as to create a deeper recess or cavity to form an open mouth; to change a portion to create a tongue, teeth, or gumline, and/or to create differently shaped and sized openings in the mouth; to create a protrusion or bump in the projection surface 402 (e.g., to mimic sticking out the tongue); etc. Because the projection surface 402 spans across an opening in the shell 404, the projection surface 402 can be pulled inwards to create the deeper recess, or can be pushed away from the shell to create a shallower or flat mouth portion. In many examples, the projection surface 402 defines an uninterrupted surface over the shell aperture or apertures (e.g., mouth openings or the like) that allows a more free form and bidirectional change of the topography of the projection surface 402. That is, the projection surface 402 can be deformed to be recessed and/or protruded from the same mechanical motion and shell support.

While in the illustrated example a motor 410 is used to modify the mouth portion of the projection surface 402, it should be understood that any mechanical mechanisms, such as motors, links, and the like, including others as discussed herein may be connected to and used to morph or modify any portion of the projection surface by either pulling skin of the projection surface or by pushing excess skin of the projection surface. Further, while in the illustrated example a link 408 is used to connect the mechanical connection 406 to the motor 410, any means of connecting the mechanical connection 406 to the motor 410 may be implemented (as discussed herein).

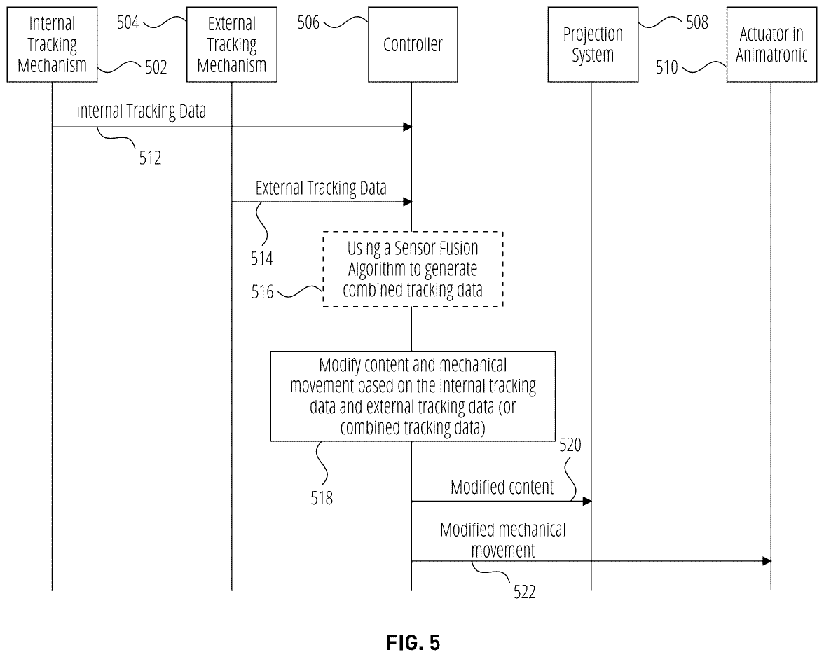

FIG. 5 is a flow diagram for tracking an animatronic and aligning content projected onto the projection surface of the animatronic and the mechanical movement of the animatronic.

The flow diagram includes an internal tracking mechanism 502 such as the tracking mechanism 316, 414, an external tracking mechanism 504 such as tracking mechanism 314, 416, a controller 506 such as the controller 104, a projection system 508 such as the projection system 108, and an actuator 510 such as the actuator 110, 306, 314 that positioned in the animatronic and used to modify the projection surface of the animatronic.

The flow diagram begins with the internal tracking mechanism 502 generating internal tracking data and communicating 512 the internal tracking data to the controller 506. The internal tracking data is generated based on movements performed by an actuator 510 used to modify the projection surface of the animatronic. The internal tracking mechanism 502 is positioned internally in the animatronic and may take various forms such as those discussed herein (e.g., encoder, IMU, camera, etc.).

Then (or at the same time), the external tracking mechanism 504 generates external tracking data and communicates 514 the external tracking data to the controller 506. The external tracking data is generated based on the external movement of the projection surface. The external tracking mechanism 504 is positioned in the environment of the animatronic (e.g., externally from the animatronic) and may take various forms such as those discussed herein (e.g., sensor, camera, marker detector, etc.).

Optionally, the controller 506, using a sensor fusion algorithm, may generate 516 combined tracking data by weighting the internal tracking data and external tracking data based on analysis of the internal tracking data, the external tracking data, the projected content, and the mechanical movement that was performed at the time of the generation of the internal tracking data and the external tracking data. The analysis may be understood as a comparison between the internal tracking data, the external tracking data, the projected content, and the mechanical movement that was performed at the time of the generation of the internal tracking data and the external tracking data as to determine whether the projected content or the mechanical movement is to be modified to achieve spatial or temporal alignment.

Accordingly, the controller 506 may modify 518 the content projected onto the projection surface (e.g., the timing of the content, or the position where the content is to be projected)) and/or the mechanical movement of the projection surface (e.g., as performed by the actuator 510) based on the internal tracking data, the external tracking data, and/or in some examples, the combined tracing data. The modification of the content may be understood as modifying the timing of the content, modifying the position that the content is projected, and/or modifying artistic aspects of the content to better align with the mechanical movements. The modification of the mechanical movement may be understood as modifying the timing of the mechanical movement, modifying the force/torque of the mechanical movement, and/or modifying which portion(s) of the projection surface is to be deformed by the mechanical movement. This may ensure that the content projected onto the projection surface and the movement of the projection surface are aligned spatially and temporally.

The controller 506 communicates 520 the modified content to the projection system 508 and communicates 522 the modified mechanical movement to the actuator 510 that is positioned in the animatronic and used to modify the projection surface. Accordingly, the projection system 508 projects the modified content onto the projection surface (or the animatronic as a whole) and the actuator 510 performs the modified mechanical movement to deform or modify the projection surface.

It should be understood that the flow diagram illustrated in FIG. 5 may be repeated (e.g., every few seconds, few milliseconds, or continuously) to align the content projected by the projection system 508 onto the projection surface with the mechanical movement of the actuator 510 spatially and temporally. Further, while a single internal tracking mechanism 502 and a single external tracking mechanism 504 are illustrated in the flow diagram of FIG. 5, one or more internal tracking mechanisms 502 and one or more external tracking mechanisms 504 may be implemented to track the animatronic. Additionally, while an actuator 510 is illustrated in the flow diagram of FIG. 5, any other mechanical elements to modify the projection surface of the animatronic may be used in place of or in combination with the actuator 510 such as the motor 410.

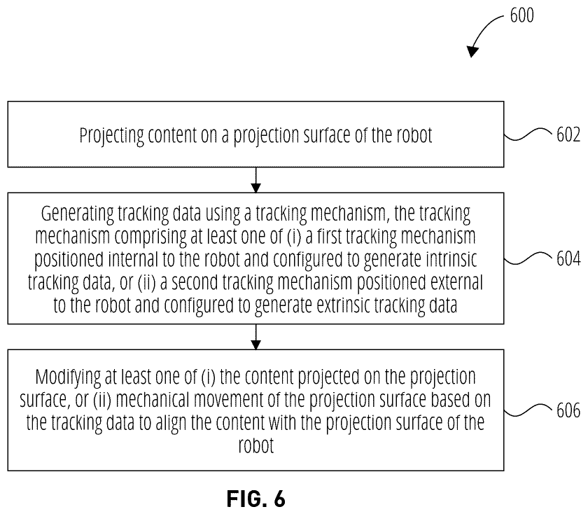

FIG. 6 illustrates a method 600 for tracking a robot (e.g., an animatronic).

The method 600 includes projecting 602 content on a projection surface of the robot. For example, a projection system 108 may project content onto a projection surface of an animatronic.

The method 600 further includes generating 604 tracking data using a tracking mechanism, the tracking mechanism comprising at least one of (i) a first tracking mechanism positioned internal to the robot and configured to generate intrinsic tracking data, or (ii) a second tracking mechanism positioned external to the robot and configured to generate extrinsic tracking data. In some examples, one or more tracking mechanisms may be positioned externally to the animatronics (e.g., in the environment of the animatronic) and may track external data corresponding to external movement of the projection surface. In some examples, one or more tracking mechanisms may be positioned internally in the animatronic to track internal data corresponding to movement of the projection surface or the mechanical elements modifying the projection surface.

The method 600 further includes modifying 606 at least one of (i) the content projected on the projection surface, or (ii) mechanical movement of the projection surface based on the tracking data to align the content with the projection surface of the robot. For example, the content projected onto the projection surface may be modified by the controller to better align the content with the movement of the projection surface based on one or both of the intrinsic tracking data and the extrinsic tracking data.

In some embodiments of the method 600, the projection surface defines a continuous projection surface over the robot.

In some embodiments of the method 600, modifying the content projected on the projection surface comprises one or more of: modifying a timing of the content projected on the projection surface, modifying a position where the content is projected on the projection surface, or modifying an artistic aspect of the content projected on the projection surface.

In some embodiments of the method 600, modifying the mechanical movement of the projection surface comprises one or more of: modifying a timing of the mechanical movement, modifying a force value or a torque value of the mechanical movement, or modifying which portion of the projection surface is moved by the mechanical movement.

In some embodiments of the method 600, the robot comprises an actuator configured to move to generate the mechanical movement, the tracking mechanism comprises the first tracking mechanism, and the first tracking mechanism generates the intrinsic tracking data based on movement of the actuator.

In some embodiments of the method 600, the tracking mechanism comprises the second tracking mechanism, and the second tracking mechanism is a visual tracking mechanism that generates the extrinsic tracking data based on tracking visual movement of a topography of a portion of the projection surface.

In some embodiments of the method 600, the tracking mechanism comprises the first tracking mechanism and the second tracking mechanism, and the method further comprises analyzing the intrinsic tracking data and the extrinsic tracking data to predict a future position of the robot, a future position of the projection surface, or a combination thereof, and further modifying at least one of the content or the mechanical movement based on the future position of the robot, the future position of the projection surface, or the combination thereof.

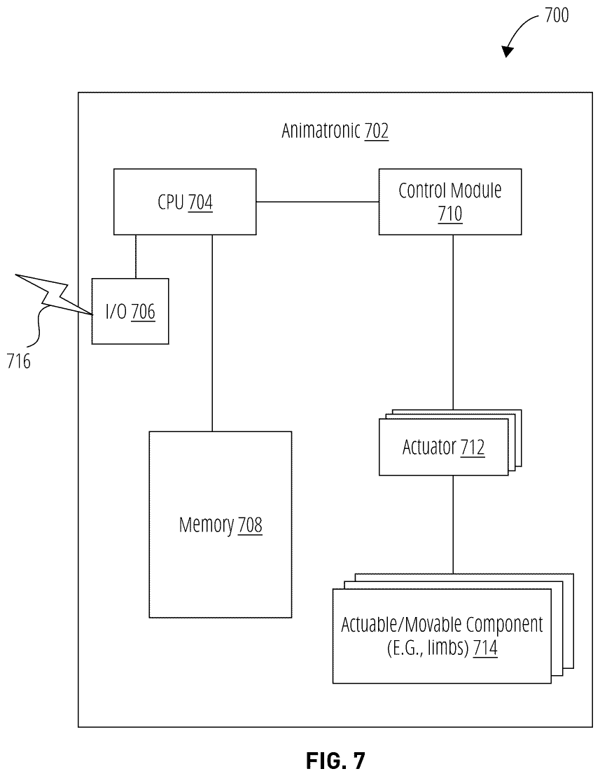

FIG. 7 illustrates a functional block diagram of an animatronic design system 700 of an animatronic702 operable or controllable according to the hybrid approach discussed herein. For example, the hybrid approach discussed herein may provide intended movements and emotions to be performed by the animatronic 702 to achieve an intended effect of an attraction. The movements and emotions (and artistic characteristics) are provided to an animatronic 702 in a wired or wireless manner as shown with arrows 716. After providing, the animatronic 702 becomes an actor with the capability to perform a role that tells a story through motion and emotion. The control policies may be a script, instructions, or mode.

The animatronic 702 may take a wide variety of forms to practice the content. In some instances, the animatronic 702 may include a pelvis, a torso, and a head, but these are not required. Further, the animatronic 702 will include one or more actuators 712 (or drivers) selectively operated by a control module 710 to actuate or drive one or more movable components 714 such as limbs with (or without) feet, arms with (or without) hands, and so on. Examples generally encompass content for a two-legged or four-legged animatronic 702, but this is not a limitation as the concepts are equally applicable to other movable components of an animatronic.

The animatronic 702 includes a processor 704 managing operations of I/O devices 706 (e.g., user device, joy-stick controller, keyboard, mouse, etc.), which are used at least to receive communications such as from a design station, which may be an ordinary personal computer (PC) workstation, laptop, or the like using software tools described in the following paragraphs. Particularly, the animatronic 702 also includes memory 708 or data storage devices for storing the content received from, for example, a server or computer where the content is generated and/or stored.

The processor 704 runs software and/or executes code/instructions (e.g., in memory 708) to provide the functionality of a control module 710. The control module 710 may be configured to include one or more artificial intelligence (AI) components and to otherwise adapt to current conditions for the animatronic 702. For example, the control module 710 may control the animatronic 702 (e.g., via control signals to the actuators 712) based on the motions in the content.

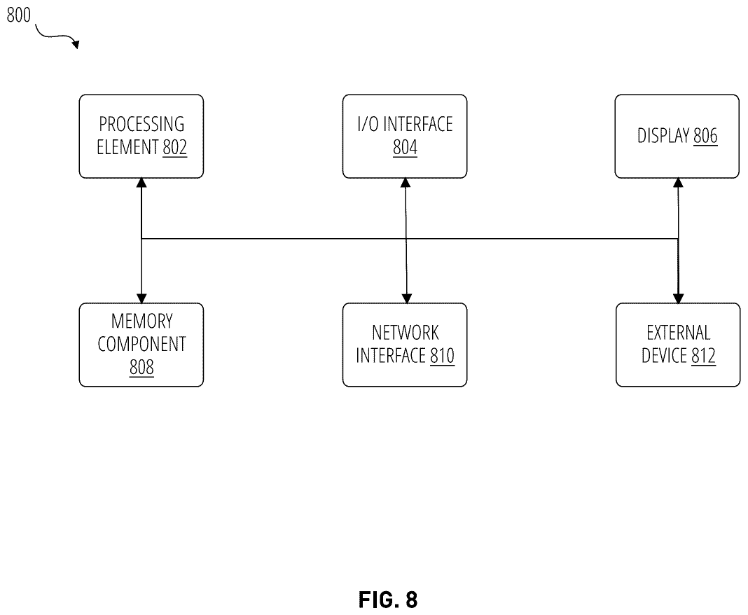

FIG. 8 is a simplified block diagram of components of a computing system 800 of the system 100, such as the server 102, the controller 104 etc. For example, the processing element 802 and the memory component 808 may be located at one or in several computing systems 800. This disclosure contemplates any suitable number of such computing systems 800. For example, the server 102 may be a desktop computing system, a mainframe, a blade, a mesh of computing systems 800, a laptop or notebook computing system 800, a tablet computing system 800, an embedded computing system 800, a system-on-chip, a single-board computing system 800, or a combination of two or more of these. Where appropriate, a computing system 800 may include one or more computing systems 800; be unitary or distributed; span multiple locations; span multiple machines; span multiple data centers; or reside in a cloud, which may include one or more cloud components in one or more networks. A computing system 800 may include one or more processing elements 802, an input/output I/O interface 804, one or more external devices 812, one or more memory components 808, and a network interface 810. Each of the various components may be in communication with one another through one or more buses or communication networks, such as wired or wireless networks, e.g., the controller 104. The components in FIG. 8 are exemplary only. In various examples, the computing system 800 may include additional components and/or functionality not shown in FIG. 8.

The processing element 802 may be any type of electronic device capable of processing, receiving, and/or transmitting instructions. For example, the processing element 802 may be a central processing unit, microprocessor, processor, or microcontroller. Additionally, it should be noted that some components of the computing system 800 may be controlled by a first processing element 802 and other components may be controlled by a second processing element 802, where the first and second processing elements may or may not be in communication with each other.

The I/O interface 804 allows a user to enter data in to computing system 800, as well as provides an input/output for the computing system 800 to communicate with other devices or services. The I/O interface 804 can include one or more input buttons, touch pads, touch screens, and so on.

The external device 812 are one or more devices that can be used to provide various inputs to the computing systems 800, e.g., mouse, microphone, keyboard, trackpad, sensing element (e.g., a thermistor, humidity sensor, light detector, etc. The external devices 812 may be local or remote and may vary as desired. In some examples, the external devices 812 may also include one or more additional sensors.

The memory components 808 are used by the computing system 800 to store instructions for the processing element 802, as well as store data. The memory components 808 may be, for example, magneto-optical storage, read-only memory, random access memory, erasable programmable memory, flash memory, or a combination of one or more types of memory components.

The network interface 810 provides communication to and from the computing system 800 to other devices. The network interface 810 includes one or more communication protocols, such as, but not limited to Wi-Fi, Ethernet, Bluetooth, etc. The network interface 810 may also include one or more hardwired components, such as a Universal Serial Bus (USB) cable, or the like. The configuration of the network interface 810 depends on the types of communication desired and may be modified to communicate via Wi-Fi, Bluetooth, etc.

The display 806 provides a visual output for the computing system 800 and may be varied as needed based on the device. The display 806 may be configured to provide visual feedback and may include a liquid crystal display screen, light emitting diode screen, plasma screen, or the like. In some examples, the display 806 may be configured to act as an input element through touch feedback or the like.

The computing system 800 may be include a physical device or separate physical devices including components to read and execute instructions from a machine-readable or computer-readable medium (e.g., a non-transitory machine-readable storage medium).

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. While the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

1. A robotic system comprising:
a projection surface coupled to a robotic structure and configured to be moved by the robotic structure;
a tracking mechanism comprising at least one of:
a first tracking mechanism positioned internal to the robotic structure and configured to generate intrinsic tracking data; or
a second tracking mechanism positioned external to the robotic structure and configured to generate extrinsic tracking data;
a controller in communication with the tracking mechanism; and
a projector having a field of view aligned with the projection surface and configured to project content onto the projection surface, wherein the controller modifies the projected content based on data generated by the tracking mechanism.

2. The robotic system of claim 1, wherein:
the tracking mechanism comprises the first tracking mechanism and the second tracking mechanism; and
the controller is further configured to combine, using a sensor fusion algorithm, the intrinsic tracking data and the extrinsic tracking data to generate combined tracking data, and use the combined tracking data to further modify the projected content.

3. The robotic system of claim 2, wherein the sensor fusion algorithm weights the intrinsic tracking data and the extrinsic tracking data based on a comparison of the intrinsic tracking data and the extrinsic tracking data to generate the combined tracking data.

4. The robotic system of claim 1, wherein the projection surface defines a continuous projection surface over the robotic structure.

5. The robotic system of claim 1, further comprising an actuator configured to change a topography of a portion of the projection surface of the robotic structure,
wherein:
the tracking mechanism comprises the first tracking mechanism;
the first tracking mechanism is coupled to the actuator; and
the first tracking mechanism generates the intrinsic tracking data based on movement of the actuator that changes the topography of the portion of the projection surface.

6. The robotic system of claim 1, wherein the tracking mechanism comprises the first tracking mechanism, and the first tracking mechanism comprises an inertial measurement unit (IMU), a hall effect detector, an encoder, or a combination thereof.

7. The robotic system of claim 1, wherein:
the tracking mechanism comprises the second tracking mechanism;
the second tracking mechanism comprises a visual tracking mechanism configured to track an external change in a topography of a portion of the projection surface; and
the second tracking mechanism is positioned within an environment of the robotic structure.

8. The robotic system of claim 1, wherein the tracking mechanism comprises the second tracking mechanism, and the second tracking mechanism comprises a light detection and ranging (LiDAR) sensor, camera, infrared (IR) marker reader, radar sensor, or a combination thereof.

9. The robotic system of claim 1, further comprising a lighting system having a field of view aligned with the projection surface and configured to project light onto one or both of the projection surface and the robotic structure,
wherein the controller is further configured to modify the lighting system based on the data generated by the tracking mechanism.

10. The robotic system of claim 1, further comprising an actuator configured to change a topography of a portion of the projection surface of the robotic structure,
wherein the controller is configured to:
time align, based on the data generated by the tracking mechanism, the content with the actuator such that the actuator modifies the topography of the portion of the projection surface at a same time as the content is projected on the portion of the projection surface; and
spatially align, based on the data generated by the tracking mechanism, the content with the projection surface such that a position where the content is projected is aligned with changes in the topography as the actuator modifies the topography.

11. A method for tracking a robot comprising:
projecting content on a projection surface of the robot;
generating tracking data using a tracking mechanism, the tracking mechanism comprising at least one of (i) a first tracking mechanism positioned internal to the robot and configured to generate intrinsic tracking data, or (ii) a second tracking mechanism positioned external to the robot and configured to generate extrinsic tracking data; and
modifying at least one of (i) the content projected on the projection surface, or (ii) mechanical movement of the projection surface based on the tracking data to align the content with the projection surface of the robot.

12. The method of claim 11, wherein the projection surface defines a continuous projection surface over the robot.

13. The method of claim 11, wherein:
modifying the content projected on the projection surface comprises one or more of:
modifying a timing of the content projected on the projection surface;
modifying a position where the content is projected on the projection surface; or
modifying an artistic aspect of the content projected on the projection surface;
and
modifying the mechanical movement of the projection surface comprises one or more of:
modifying a timing of the mechanical movement;
modifying a force value or a torque value of the mechanical movement; or
modifying which portion of the projection surface is to be moved by the mechanical movement.

14. The method of claim 11, wherein the robot comprises an actuator configured to move to generate the mechanical movement, the tracking mechanism comprises the first tracking mechanism, and the first tracking mechanism generates the intrinsic tracking data based on movement of the actuator.

15. The method of claim 11, wherein the tracking mechanism comprises the second tracking mechanism, and the second tracking mechanism is a visual tracking mechanism that generates the extrinsic tracking data based on tracking visual movement of a topography of a portion of the projection surface.

16. The method of claim 11, wherein the tracking mechanism comprises the first tracking mechanism and the second tracking mechanism, and the method further comprises:
analyzing the intrinsic tracking data and the extrinsic tracking data to predict a future position of the robot, a future position of the projection surface, or a combination thereof; and
further modifying at least one of the content or the mechanical movement based on the future position of the robot, the future position of the projection surface, or the combination thereof.

17. A non-transitory computer-readable media comprising instructions to cause a robotic system to:
generate tracking data using a tracking mechanism, the tracking mechanism comprising at least one of (i) a first tracking mechanism coupled internally to a robotic structure of the robotic system robot and configured to generate intrinsic tracking data, or (ii) a second tracking mechanism positioned externally to the robotic structure robot and configured to generate extrinsic tracking data; and
modify, based on the tracking data, at least one of (i) content projected on a projection surface of the robotic system, or (ii) mechanical movement of the projection surface to align the content with the projection surface of the robot.

18. The non-transitory computer-readable media of claim 17, wherein the projection surface defines a continuous projection surface over the robotic structure.

19. The non-transitory computer-readable media of claim 17, wherein the instructions further cause the robotic system to:
analyze the tracking data to predict one or both of a future position of the projection surface or a future movement of the projection surface; and
further modify at least one of the content projected on the projection surface or the mechanical movement of the projection surface based on the one or both of the future position of the projection surface or the future movement of the projection surface.

20. The non-transitory computer-readable media of claim 17, wherein the instructions further cause the robotic system to spatially align and time align, based on the tracking data, the content projected on the projection surface, and the mechanical movement of the projection surface.
